(19) United States
(12) Patent Application Publication
(10) Pub. No.: US 2026/0329387 A1
(43) Pub. Date: Oct. 22, 2026

(54) GESTURE CONTROL

(71) Applicant: Carl Zeiss Microscopy GmbH, Jena (DE)

(72) Inventors: Martin KRENNER, Unterhaching (DE); Sebastian Albrecht, München (DE)

(73) Assignee: Carl Zeiss Microscopy GmbH, Jena (DE)

(21) Appl. No.: 19/537,609

(22) Filed: Feb. 12, 2026

(30) Foreign Application Priority Data
Feb. 13, 2025 (DE) 10 2025 105 339.1

(51) Int. Cl. G06F 3/01; G02B 21/36

(52) U.S. Cl. CPC G06F 3/017; G02B 21/368; G06F 3/013

(57) ABSTRACT

A module for a microscope for determining a gesture-based operating input by a user and for controlling a function of a microscope is provided, comprising an input interface for receiving operating data from a control panel of an input device with information relating to an operating input by the user; an analysis unit for detecting whether the operating input by the user is the gesture-based operating input and for determining a control command for controlling the function of the microscope based on the gesture-based operating input; and an output interface for transmitting the control command to a control unit of the microscope to control the function of the microscope; wherein detecting of the operating input takes place on a complete control panel of the input device independently of a content displayed thereon.

### CROSS REFERENCE TO RELATED APPLICATION

This application claims priority to German patent application 10 2025 105 339.1 filed on Feb. 13, 2025, which is hereby incorporated by reference in its entirety.

### TECHNICAL FIELD

The present disclosure relates to a module for a microscope for determining a gesture-based operating input by a user and for controlling a microscope function. The present disclosure further relates to a corresponding system as well as a microscope. The present disclosure furthermore relates to a method for operating a microscope as well as a computer program.

### BACKGROUND

Operation of a microscope when looking through one or two eyepieces can be challenging for a user. Microscopes can have operating elements for setting different microscope functions, such as, for example, of a focus, of a zoom or of a movement of the sample below or above the objective. In some instances, the user cannot see these operating elements when looking through the eyepiece or the eyepieces, respectively, of the microscope in order to view a sample. In some instances, the user must thus feel for the operating elements or must operate the operating elements blindly, respectively, and check the effects of the operation when looking through the eyepieces.

Microscopes can be controlled via rotary knobs or other operating elements, which can be reached easily and which can be operated without direct view of the operating element. For example, a focus and/or a zoom level, thus a magnification of the microscope, can be set by means of rotary knobs.

A user input of this type can be made via a touch screen, whereby a display of operating icons takes place on the touch screen for this purpose and a complex menu navigation has to occasionally take place through the different operating options. Additionally, or alternatively, an image section of a sample image can be displayed on the touch screen.

### SUMMARY

A module for a microscope for determining a gesture-based operating input by a user and for controlling a function of a microscope is provided. The module comprises an input interface for receiving operating data from a control panel of an input device with information relating to an operating input by the user; an analysis unit for detecting whether the operating input by the user is the gesture-based operating input and for determining a control command for controlling the function of the microscope based on the gesture-based operating input; and an output interface for transmitting the control command to a control unit of the microscope to control the function of the microscope; wherein detecting of the operating input takes place on a complete control panel of the input device independently of a content displayed thereon.

A method for operating a microscope is provided. The method comprises receiving sensor data from a control panel on an input device with information relating to an operating input by a user; detecting whether the operating input by the user is gesture-based operating input, wherein detecting the operating input takes place on a complete control panel of an input device, independently of the displayed content; determining a control command based on the gesture-based operating input for controlling the function of the microscope; and transmitting the control command to a control unit of the microscope to control at least one function of the microscope.

### BRIEF DESCRIPTION OF THE DRAWINGS

In the drawings:
FIG. 1 shows a schematic illustration of an example system comprising an input device and a module;
FIGS. 2a-2c show a schematic illustration of examples of different digital layers for detecting an operating input;
FIG. 3 shows a diagram for clarifying a function of a microscope with a system according to the disclosure;
FIG. 4 shows a schematic illustration of a microscope with a system according to the disclosure;
FIG. 5 shows a schematic illustration of a further microscope with control units and a system according to the disclosure; and
FIG. 6 schematically shows the steps of an example method according to the disclosure.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

There can be a need for providing an improved operability of a microscope. This need can increase with additional functions, which can be integrated in modern microscopes.

The present disclosure can solve the object of specifying an improved and optionally intuitive option for controlling a microscope. A reliable operation of the microscope may be made possible, wherein, optionally, a gaze of a user has not to leave the sample for this purpose. An option may be created for operating a microscope without the input device being illuminated for this purpose, so that less scattered light is present when viewing the sample.

In a first aspect, the disclosure can relate to a module for a microscope for determining a gesture-based operating input by a user and for controlling a microscope function, optionally comprising: an input interface for receiving operating data from a control panel of an input device, preferably a touch screen, with information relating to an operating input by the user; an analysis unit for detecting whether the operating input by the user is gesture-based and for determining a control command for controlling the function of the microscope based on the gesture-based operating input; and an output interface for transmitting the control command to a control unit of the microscope in order to control the function of the microscope, wherein the detection of the operating input takes place on a complete control panel of the input device independently of a content displayed thereon. In other words, the complete control panel can be used for inputting a gesture-based operating input.

In a further aspect, the disclosure can relate to a system for determining a gesture-based operating input by a user and for controlling a microscope function, optionally comprising: a module as defined above; and an input device with a control panel, preferably in the form of a touch screen, for generating operating data based on an operating input by the user.

In a further aspect, the disclosure can relate to a microscope with a system as defined above and a control unit, which controls a function of the microscope based on a control command of the analysis unit of the module.

The disclosure furthermore can relate to a method for operating a microscope, optionally comprising the steps of: receiving sensor data from a control panel of an input device with information relating to an operating input by a user; detecting whether the operating input by the user is gesture-based; determining a control command based on the gesture-based operating input for controlling the function of the microscope; and transmitting the control command to a control unit of the microscope in order to control at least one function of the microscope, wherein the detection of the operating input takes place on a complete control panel of the input device, independently of the content displayed there.

The above-mentioned features and the features, which will be explained below, cannot only be used in the respective specified combination but also in other combinations or alone without leaving the scope of the present disclosure. The system, the microscope and/or the method can be implemented according to the designs described for the module and vice versa.

Microscope function can be understood to be all adjusting and operating options of a microscope, such as, for example, a zoom, thus a magnification level, a focusing, a moving of the sample, an adjusting of lighting, a setting of an optical filter, for example of a polarization filter, a turn-on and turn off of additional lighting, optionally of wavelength-dependent additional lighting. A staining of a sample and/or an automated change of the objective can also be understood as microscope function. Storage functions of a sample image or the like can additionally be understood as functions.

An output interface for transmitting the control command to a control unit of the microscope can provide for a highly flexible module, which can be combined with a plurality of control units of the microscope.

An input interface for receiving operating data from a control panel of an input device can provide for a highly flexible module, which can be combined with a plurality of input devices.

Interfaces can be provided such that units already present in the microscope can be used with the module. The disclosure can be suitable as a retrofit solution and can optionally be implemented cost-efficiently because few components or units are required for the realization.

A common input and output interface can be provided, i.e., the input and output may be combined in one input/output interface. The above-mentioned interfaces can be formed in a wired as well as wireless manner, whereby any standard or also a proprietary communication can be applied for this.

A microscope equipped with a system of this type can offer the opportunity of supplying a user with a microscope with an advantageous control and improved operability directly during the delivery. In the case of a direct combination of microscope and system, the system can be integrated into the microscope in an advantageous manner.

Operating input can be understood as making an input using a touch panel or control panel of an input device. Regular operating inputs can take place hereby, for example the actuation of a button or the sliding of a slide control, which are displayed on the control panel. In this respect, the operating input optionally takes place on an input device in the form of a touch screen. Operating input can also be understood to be a two-finger zoom on a displayed image section, in the case of which two fingers are placed at a small distance on the control panel and are then pulled apart. This input can be a regular or a gesture-based operating input, depending on the application. A gesture-based operating input can be, for example, a swiping with one or several fingers. A gesture can also comprise the tracing of a predetermined trajectory on the control panel. A gesture can comprise the operation of the control panel with more than one finger, whereby a plurality of movements and gestures can be performed hereby. Gesture can also be understood to be the placement of the entire palm or the swiping with the edge of a finger or the like.

A module can be formed as independent hardware unit. The module can be realized as software on already installed hardware, so that the disclosure can also be realized as a retrofit solution, optionally in the form of an update or upgrade. A cost-efficient and efficient option for improving already existing microscope systems, which are already equipped with corresponding hardware, can take place hereby.

By detecting whether the operating input by the user is gesture-based and determining a control command for controlling the microscope function based on the gesture-based operating input, a regulation can be created, which prioritizes gesture-based operating inputs, so that overriding of the lower microscope function or operation can be attained. An intuitive and menu-independent control of the microscope can take place, so that microscope functions can be operated quickly and directly, optionally without having to look at the input device.

For this purpose, the analysis unit can create two digital layers, wherein one layer reflects the classic, regular operation, and one layer reflects the gesture-based operation or control, respectively. The operating input can then be detected and it can be determined based on the operating input itself or on the basis of the lower operating menu of the regular operating layer, whether it is a gesture-based or regular operating input. The analysis unit can then prompt the regular operation itself by means of a control command or can transfer the operating input to a connected module, so that this module further processes the operating input. Alternatively, the analysis unit can interpret the gesture of the gesture-based operating input and based on the detected gesture, can generate a control command, which prompts a control unit of the microscope to perform the desired function.

Due to the fact that the detection of the operating input takes place on a complete control panel of the input device independently of a content displayed thereon, it can be reliably ensured that a gesture-based operating input can be captured and detected. The term “displayed content” can also comprise that no content is displayed, thus, in the example of a touch screen, a gesture is performed on a black screen. This application can be advantageous when measurement is to take place during low-light conditions using the microscope because a scattered light influence from a touch screen input device can be prevented hereby.

The gestures provided for operating the microscope or the microscope functions, respectively, can be conflict-free with regard to regular operating inputs. In other words, the gestures can differ from a simple tapping or sliding of a displayed slide control or moving of a controller, so that it can be detected reliably whether it is a gesture or a regular operating input. Time thresholds can also be defined for this purpose. A gesture can thus be detected, for example, when one or several fingers of the user touch the input device for a longer period of time.

The analysis unit can be formed for detecting whether the operating input by the user is regular and for generating a control command based on the regular operating input and on a content displayed on the input device. An advantageous module can be created hereby, which has the ability of interpreting and processing gesture-based as well as regular operating inputs. A quicker operation of the microscope function can take place hereby, if said microscope function is based on a regular operating input because a transfer of the operating input does not have to take place but it can be processed directly.

The analysis unit can be formed for detecting a switchover gesture and, after detection of the switchover gesture, for changing into a gesture mode, in which only gestures act as operating inputs. Additionally, or alternatively, the analysis unit can be formed for leaving the gesture mode after detecting a change gesture. It can be ensured by means of a gesture mode that gestures are detected securely and reliably. A quicker processing can further take place because the detection whether it is a gesture is unique in this case. Optionally, a gesture-based operating input is always assumed in this case. In this case, the step of detecting can thus always lead to the result that it is a gesture as operating input. The switchover gesture and the change gesture can comprise the same gestures. Hereby, a change into the gesture mode can be made or the gesture mode can be left by touching the control panel with two or three fingers for a time span of, for example, two seconds. Other change or switchover gestures are also conceivable.

A regular mode can be provided, in the case of which each operating input is interpreted as regular operating input and no gesture-based control takes place.

The analysis unit can be formed for determining, based on user data, whether a gaze of a user is directed at the control panel, and for detecting a regular operating input when the operating input by the user is ambiguous or plurivalent and the gaze of the user is directed at the control panel. Additionally, or alternatively, the analysis unit can be formed for detecting a gesture-based operating input when the operating input by the user is ambiguous or plurivalent and the gaze of the user is directed away from the control panel, wherein the user data preferably originates from an eye sensor, in particular an eye tracking sensor, on the eyepiece of the microscope and/or a camera. The operating comfort for a microscope can be increased hereby and the acceptance of the gesture-based input method can be improved. User data can provide for a reliable determination whether the user looks at the control panel. A regular operating input can be only very likely when the user looks at the control panel. Other user data can also be used, which provide information as to whether the gaze of the user is directed at the control panel.

The analysis unit can be formed for generating a control command, which causes the output of an acknowledgement signal when a gesture is detected, optionally when the change gesture and/or the switchover gesture is detected. By outputting an acknowledgement signal, an operability of the microscope can be further improved. It can optionally be attained hereby that a user obtains direct feedback about the operating input made by him/her. An acknowledgement signal can be present, for example, in the form of an acoustic signal, a haptic signal, for example a vibrating input device, or an optical signal or a combination of the above-named.

The module can comprise an artificial intelligence (AI) unit, which is formed for improving the gesture detection in a self-learning manner, optionally in a user-specific manner, based on a detected gesture and a subsequent behavior of a user. A steadily improving module can be created hereby, which provides for an increasingly improved operability. An acceptance of the system can be further increased hereby. Optionally, the AI unit can hereby monitor the subsequent behavior of the user. For example, when the user reverses the function triggered by the detected gesture, it can be detected with high probability that there was a misinterpretation of the gesture. From a subsequent behavior, which does not comprise any further operating inputs for a predefined time span, it can be concluded with high probability that the gesture was detected correctly and that the function was carried out in the way the user had intended it.

The analysis unit of the module or the module itself can be formed, for example, as part of a control unit, which is already installed in the microscope, wherein the system can optionally fall back here on an already existing communication infrastructure of the individual modules of the microscope. The analysis unit of the module or the module itself can also be formed as part of a personal computer (PC), which is connected to the microscope.

A system 10 with an input device 12 comprising a control panel 14 and a module 16 is shown schematically in FIG. 1.

The input device 12 can comprise, for example, a touch screen, which reacts in a touch-sensitive manner to the touch of a hand, for example of one or several fingers, on the control panel 14 and transmits corresponding operating data to the module 16.

The module 16 comprises an input interface 18, an analysis unit 20 and an output interface 22.

The input interface 18 is formed for receiving the operating data from the input device 12 with information relating to an operating input.

The operating data can be processed by the analysis unit 20, wherein a differentiation is in particular made hereby, whether it is a gesture-based operating input or a regular operating input.

If a gesture-based operating input is detected, a control command for controlling a microscope function based on the gesture-based operating input is determined.

If a regular operating input is detected, a control command can be generated based on the regular operating input and preferably based on a content displayed on the input device. Alternatively, the operating input can also be transferred to a non-illustrated further control unit, so that this control unit can then generate a corresponding control command.

The output interface is formed for transmitting the control command to a control unit 24 of the microscope to prompt the control unit 24 by means of the control command to control the function of the microscope according to the operating input.

The detection of the operating input can take place on the complete region of the control panel 14 of the input device 12. The detection of the operating input in particular takes place independently of a content displayed on the input device 12 to be able to securely detect each gesture-based operating input.

Three control units 24 are illustrated in an exemplary manner in FIG. 1. One control unit 24a serves the purpose of controlling an XY table to shift the XY table with a sample arranged thereon on a sample carrier.

One control unit 24b serves the purpose of changing an objective, for example with the use of an objective turret, which can change the objectives by rotating.

One control unit 24c serves the purpose of changing and/or dimming a light source for illuminating the sample.

The above-mentioned control units are selected only in an exemplary manner to clarify the disclosure and are not intended to be limiting. Other control units are possible within the scope of the disclosure.

Different digital layers 26, 28 for detecting an operating input 30 are illustrated schematically in FIGS. 2a to 2c.

The complete surface of the control panel is illustrated in a simplified manner in a first layer 26 in FIG. 2a. Different operating icons 34 are illustrated schematically in a second layer 28. If the user makes an operating input 30 with his/her hand 32, this operating input 30 can be gesture-based or regular.

If a regular input takes place, the digital second layer 28 is used and a control command, which carries out the desired function, is generated from the operating input 30 in combination with the illustrated operating icons 34.

If a gesture-based operating input 30 is made, preferably the complete surface of the control panel is relevant. A movement or a number of touches or the like on the complete control panel can hereby be detected and can be evaluated or interpreted subsequently, respectively. This is illustrated symbolically by a dashed line in the first digital layer 26.

In contrast to FIG. 2a, a sample image 36 is displayed in FIG. 2b instead of the operating icon 34 on the second digital layer 28. A gesture-based operation 30 hereby takes place, for example, by means of a two-finger zoom input or a moving of the displayed sample image 36. In contrast, a regular operation in this example could comprise that marking points are placed on the sample image 36 by simply tapping or that operating icons or buttons, which are displayed on the sample image 36, are tapped. For the sake of clarity, an additional display of the operating icons or marking points has been forgone. A differentiation between a gesture-based operating input 30 and a regular input can also be made in this case.

A situation is illustrated in FIG. 2c, in which the operating icons 34 comprise, for example, a slide control for a brightness of a sample illumination. Conflicts between a swiping gesture, which would be detected in the first layer 26, and the actuation of the slide control, which would be detected in the second layer 28, could occur hereby.

A prioritization should take place in this case because preferably only one function is to be controlled for each operating input 30. Different options can be used hereby. For example, a user behavior of the past can be used in order to determine which operating input 30 the user wants. User data could be present, which provide information as to whether the user looks at the control panel and in particular the operating icon 34 in order to determine from this whether the user wants to operate in a gesture-based or regular manner. It is also conceivable to output a warning sound when the operating input 30 was not clear.

Using this example, it can be clearly illustrated that the gestures preferably differ from regular operating inputs, are thus conflict-free, with respect to the inputs, which are to be made on the control panel.

A differentiation can, for example, take place based on time, whereby the duration of a touch of the control panel is detected here. The trajectories, which are traced on the control panel with one or several fingers, can in particular differ strongly.

A diagram for clarifying a function of a microscope with a system according to the disclosure is shown in a simplified manner in FIG. 3.

The operating input 30 takes place on the left side of the diagram. This operating input 30 is converted into operating data, which is then transmitted to the module 16.

The module 16 processes the operating data and determines therefrom, whether it is a gesture-based operating input 30, as illustrated on the top in the figure, or a regular operating input 30, as illustrated on the bottom in the figure.

Based on the operating input 30, the module 16 then determines a corresponding control command for controlling a microscope function and transmits this control command to a control unit 24, so that the execution of the desired function is performed.

A microscope 40 with a system 10 according to the disclosure is illustrated schematically in FIG. 4.

The microscope 40 comprises an eye tracking sensor 42, which is arranged on an eyepiece of the microscope 40. If a user 38 looks through the eyepiece of the microscope 40, this is detected by the eye tracking sensor 42. In the time period, in which the user 38 looks through the eyepiece of the microscope 40, there is a very high probability that operating inputs take place in the form of gesture-based operating inputs.

Additionally or alternatively, the viewing direction of the user 38 can also be detected by means of a camera 44.

A microscope 40 with a system 10 according to the disclosure is illustrated in more detail in FIG. 5. Identical reference numerals are based on identical features and will not be explained again.

In contrast to the embodiments shown so far, the microscope 40 according to FIG. 5 has a signal unit 50. In the shown example, the signal unit 50 is formed as a loudspeaker and can be controlled by the module 16 in order to output an acknowledgement tone.

The module can output, for example, an acknowledgement tone when detecting a gesture in order to convey to the user that the gesture-based input was detected.

Alternatively, a change into a gesture mode can be provided. This can take place, for example, by means of a switchover gesture or a different operating input. Setting up the gesture mode can be confirmed by means of a further acknowledgement signal or a further acknowledgement tone, respectively.

In the gesture mode, each operating input is interpreted as gesture-based operating input.

The gesture mode can be left again, for example, by means of a change gesture, wherein the module 16 can output a further acknowledgement tone for this purpose by means of the signal unit 50.

It goes without saying that specific signal tones can be provided for individual gestures and/or the entering or leaving of the gesture mode.

To better understand the disclosure, an eye tracking sensor 42 for detecting one eye 46 or both eyes 46 of the user as well as individual control units 24 are further displayed in the figure.

One control unit 24a serves the purpose of controlling an XY table. One control unit 24b serves the purpose of changing an objective, for example by means of an objective turret. One control unit 24c serves the purpose of changing and/or dimming a light source 48 for illuminating the sample.

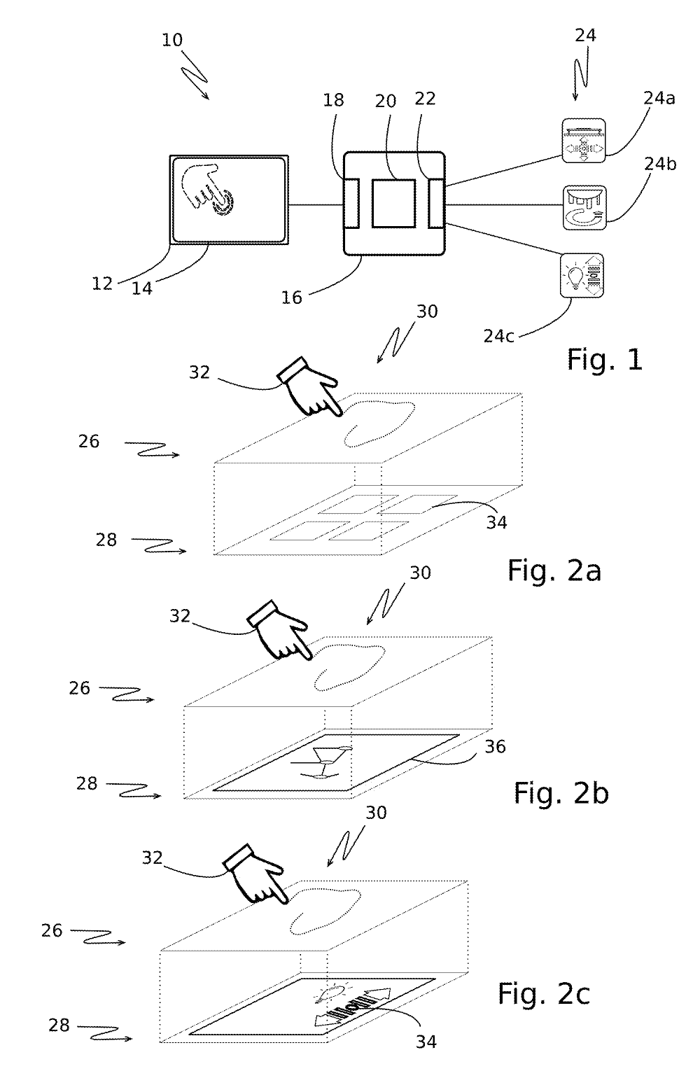

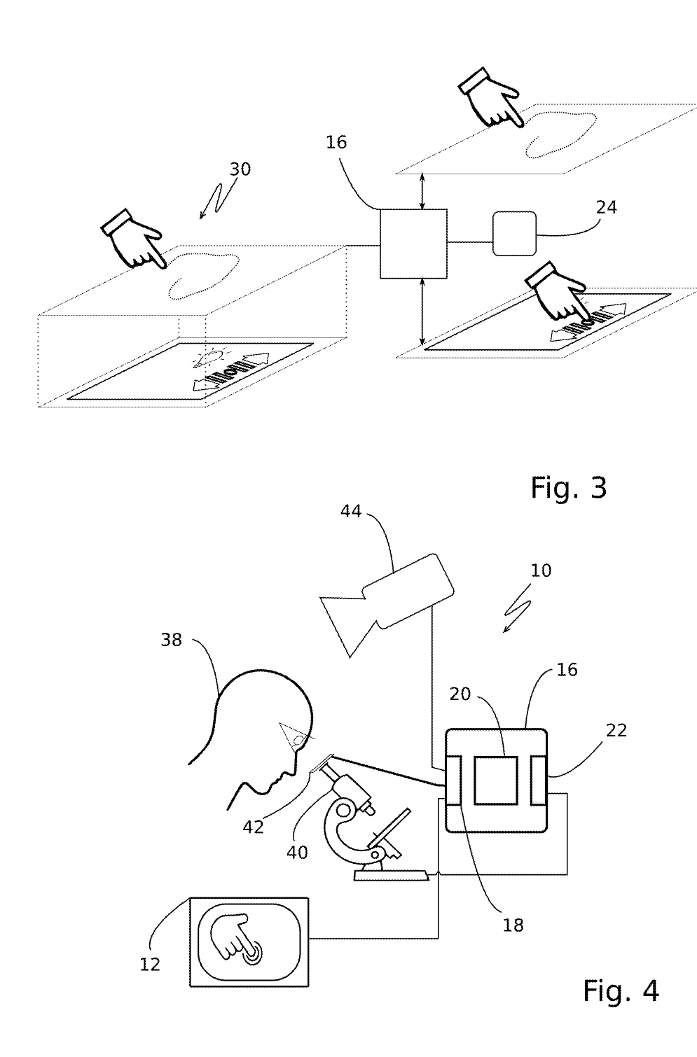

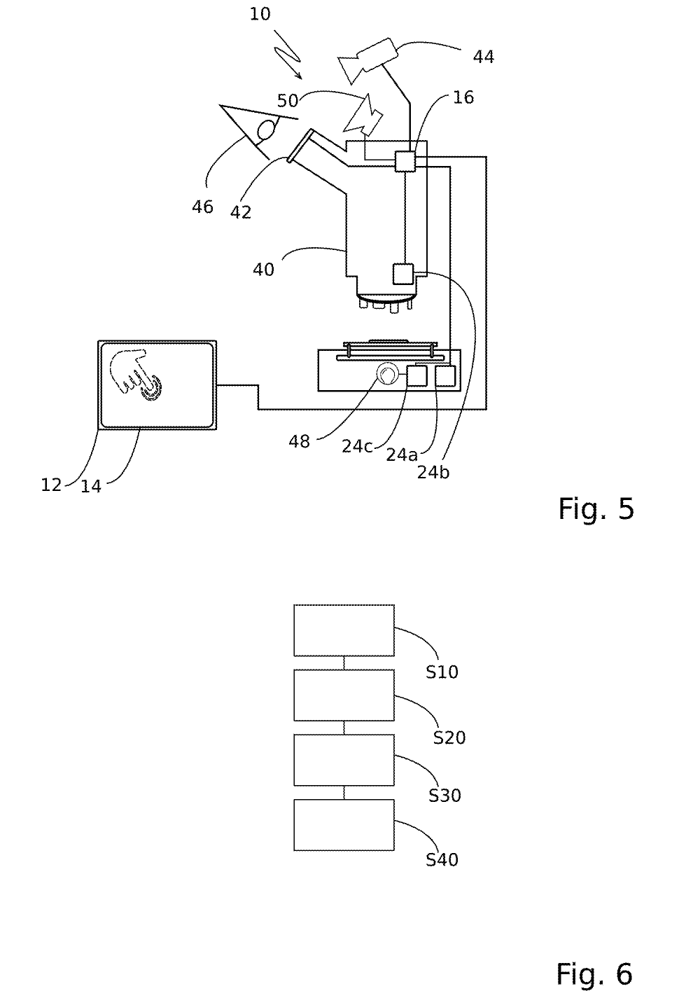

The steps of a method according to the disclosure for operating a microscope are illustrated schematically in FIG. 6.

In a first step S10, a receiving of sensor data from a control panel takes place at an input device with information relating to an operating input by a user.

In a second step S20, it is detected whether the operating input by the user is gesture-based.

In a third step S30, a control command based on the gesture-based operating input is then determined for controlling the function of the microscope.

Lastly, in a fourth step S40, a transmission of the control command to a control unit of the microscope takes place to control at least one function of microscope.

The detection of the operating input preferably takes place on a complete control panel of an input device, independently of content displayed thereon.

In the case at hand, a detection on the complete control panel of an input device is to be understood in such a way that the complete control panel can be used but does not necessarily have to be used for making the input. A person of skill in the art recognizes that a part of the control panel can also be used for a gesture-based input. This expression can mean that the gesture-based operating input is not limited to predefined regions of the control panel. However, it can be provided in a preferred embodiment to provide certain regions for a gesture-based operating input.

The disclosure has been described and explained comprehensively based on the drawings and the description. The description and explanations are to be understood as non-limiting examples. The disclosure is not limited to the disclosed embodiments. Other embodiments or variations follow for the person of skill in the art when using the present disclosure as well as in the case of an accurate analysis of the drawings, of the disclosure and of the following patent claims.

The words “comprise” and “with” in the patent claims do not rule out the presence of further elements or steps. The indefinite article a or an does not rule out the presence of a plurality. An individual element, module, device or an individual unit can carry out the functions of several of the units, elements, modules, devices mentioned in the patent claims. An element, a unit, an interface, a device, a module and a system can be partially or completely implemented in hardware and/or in software. The pure naming of some measures in several different dependent patent claims is to not be understood in such a way that a combination of these measures cannot likewise be used in an advantageous manner. Reference numerals in the patent claims are not to be understood to be limiting.

### REFERENCE SYMBOLS

10 system
12 input device
14 control panel
16 module
18 input interface
20 analysis unit
22 output interface
24 control unit
26 layer
28 layer
30 operating input
32 hand
34 operating icon
36 sample image
38 user
40 microscope
42 eye tracking sensor
44 camera
46 eye
48 light source
50 signal unit
S10 to
S40 steps of a method according to the disclosure

What is claimed is:

1. A module for a microscope for determining a gesture-based operating input by a user and for controlling a function of a microscope, comprising:
an input interface for receiving operating data from a control panel of an input device with information relating to an operating input by the user;
an analysis unit for detecting whether the operating input by the user is the gesture-based operating input and for determining a control command for controlling the function of the microscope based on the gesture-based operating input; and
an output interface for transmitting the control command to a control unit of the microscope to control the function of the microscope;
wherein detecting the operating input takes place on a complete control panel of the input device independently of a content displayed thereon.

2. The module according to claim 1, wherein the analysis unit is configured for detecting whether the operating input by the user is a regular operating input and for generating the control command based on the regular operating input and on the content displayed on the input device.

3. The module according to claim 1, wherein the analysis unit is configured for detecting a switchover gesture and for changing into a gesture mode after detection of the switchover gesture, in which only gestures act as operating inputs, and/or for leaving the gesture mode after detecting a change gesture.

4. The module according to claim 1, wherein the analysis unit is configured for detecting, based on user data, whether a gaze of the user is directed at the control panel, and for detecting a regular operating input when the operating input by the user is ambiguous or plurivalent and the gaze of the user is directed at the control panel.

5. The module according to claim 1, wherein the analysis unit is configured for detecting the gesture-based operating input when the operating input by the user is ambiguous or plurivalent and a gaze of the user is directed away from the control panel.

6. The module according to claim 4, wherein the user data originates from an eye sensor and/or an eye tracking sensor, on an eyepiece of the microscope and/or a camera.

7. The module according claim 1, wherein the analysis unit is configured for generating the control command which causes the output of an acknowledgement signal when a gesture is detected.

8. The module according to claim 3, wherein the analysis unit is configured for generating the control command which causes the output of an acknowledgement signal when the change gesture and/or the switchover gesture is detected.

9. The module according to claim 1, comprising an artificial intelligence (AI) unit configured for improving the detecting of whether the operating input by the user is the gesture-based operating input in a self-learning manner based on a detected gesture and a subsequent behavior of the user.

10. The module according to claim 9, wherein the AI unit is configured for improving the detecting of whether the operating input by the user is the gesture-based operating input in a user-specific manner.

11. A system for determining a gesture-based operating input by a user and for controlling a microscope function, comprising:
the module according to claim 1; and
the input device with the control panel for generating operating data based on the operating input by the user.

12. A microscope, comprising the system according to claim 11 and a control unit configured for controlling a function of the microscope based on the control command of the analysis unit of the module.

13. A method for operating a microscope, comprising:
receiving sensor data from a control panel on an input device with information relating to an operating input by a user;
detecting whether the operating input by the user is a gesture-based operating input, wherein detecting the operating input takes place on a
complete control panel of an input device, independently of displayed content;
determining a control command based on the gesture-based operating input for controlling a function of the microscope; and
transmitting the control command to a control unit of the microscope to control at least one function of the microscope.

14. A non-transitory computer-readable medium storing instructions that, when executed by one or more processors, cause the one or more processors to perform the method of claim 13.
